(19) United States
(12) Patent Application Publication
(10) Pub. No.: US 2020/0335090 A1
(43) Pub. Date: Oct. 22, 2020

(54) PROTECTING CHAT WITH ARTIFICIAL INTELLIGENCE

(71) Applicant: INTERNATIONAL BUSINESS MACHINES CORPORATION, Armonk, NY (US)

(72) Inventors: Andrew R. Freed, Cary, NC (US); Sorabh Murgai, Cary, NC (US); Aaron T. Smith, Raleigh, NC (US); Devasena Vridhachalam, Cary, NC (US); Jasmeet Singh, High Point, NC (US); Rebecca Rose James, Cary, NC (US)

(21) Appl. No.: 16/458,681

(22) Filed: Jul. 1, 2019

Related U.S. Application Data
(63) Continuation of application No. 16/385,823, filed on Apr. 16, 2019.

(51) Int. Cl. G10L 15/16; G06N 3/08; A63F 13/87; G06F 16/683; G06N 5/02

(52) U.S. Cl. CPC G10L 15/16; G06N 3/08; H04L 67/306; G06F 16/685; G06N 5/02; A63F 13/87

(57) ABSTRACT

A method, computer system, and computer program product for chat protection. The embodiment may include receiving, in a chat session, a user-spoken communication and one or more inputs specific to a software program. The embodiment may also include predicting a next communication by the user based on the received user spoken communication and the one or more inputs. The embodiment may further include, in response to the predicted next communication containing untoward content, performing a remedial action.

### BACKGROUND

The present invention relates generally to the field of computing, and more particularly to chat software.

Chat software relates to systems that allow interactions (e.g., text, voice, or video exchanges) between users. Some chat software allows the transmission of video or audio between users as well as file transfers. Various different types of software allow for the integration of chat software to allow for user interactions in various software environments. For example, video game software that incorporates multiplayer functionality may integrate chat software to allow users to communicate, either through user-entered text or microphone-captured voice data, with each other during play.

### SUMMARY

According to one embodiment, a method, computer system, and computer program product for chat protection. The embodiment may include receiving, in a chat session, a user-spoken communication and one or more inputs specific to a software program. The embodiment may also include predicting a next communication by the user based on the received user spoken communication and the one or more inputs. The embodiment may further include, in response to the predicted next communication containing untoward content, performing a remedial action.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a chat protection process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to chat software. The following described exemplary embodiments provide a system, method, and program product to, among other things, generate and adapt a neural network to predict what language may be subsequently spoken in a chat environment. Therefore, the present embodiment has the capacity to improve the technical field of chat software by preventing untoward content from being transmitted to an entire group in real-time rather than through a delay mechanism, which may be critical in some chat software use case scenarios.

As previously described, chat software relates to systems that allow interactions (e.g., text, voice, or video exchanges) between users. Some chat software allows the transmission of video or audio between users as well as file transfers. Various different types of software allow for the integration of chat software to allow for user interactions in various software environments. For example, video game software that incorporates multiplayer functionality may integrate chat software to allow users to communicate, either through user-entered text or microphone-captured voice data, with each other during play. Social interactions within the chat environment is a critical feature of chat software. However, since some chat environments, such as multiplayer video games, allow users of all ages to interact, untoward content, such as explicit words, innuendos, and bullying, may be presented to either the entire group or a specific individual.

Some existing solutions to preventing untoward content from reaching individuals is typically a one-size-fits-all remedy, such as age-restricted participation or wholesale muting or chat unavailability of social/audio to an entire group. The one-size-fits-all remedies fail to incorporate users of diverse demographics into a group environment while also protecting each user from untoward content that may apply to each specific user individually. For example, incorporating minors into a group that also includes adults may subject the group of minors to explicit words or phrases not typically suitable for that specific age group. However, muting the entire group blocks user interaction and may lessen the overall intended user experience.

According to one embodiment, a neural network may be generated and utilized to predict what specific language may be spoken next in a voice chat environment based on previously spoken words or phrases and historic user interactions stored within a repository. Furthermore, additional program context may be considered making predictions based on the program state and user sentiment. For example, in a video game chat environment, game state/events and player sentiment to the current actions within the video game may be considered when predicting the next words that may be spoken.

The predicted language may be analyzed and compared to a dictionary to determine if the predicted language contains any untoward content. Should the predicted language in fact contain untoward content a remedial action may be performed for a sender and a receiver. For example, the sender may have a corresponding microphone muted for a preconfigured period of time and a recipient may have the entire phrase containing the untoward content muted so as to prevent the recipient from hearing any possibly offensive language.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to predict upcoming language that may be spoken in a chat environment using a neural network and, upon determining the predicted language contains untoward content, performing a remedial action that prevents a recipient from being exposed to the untoward content.

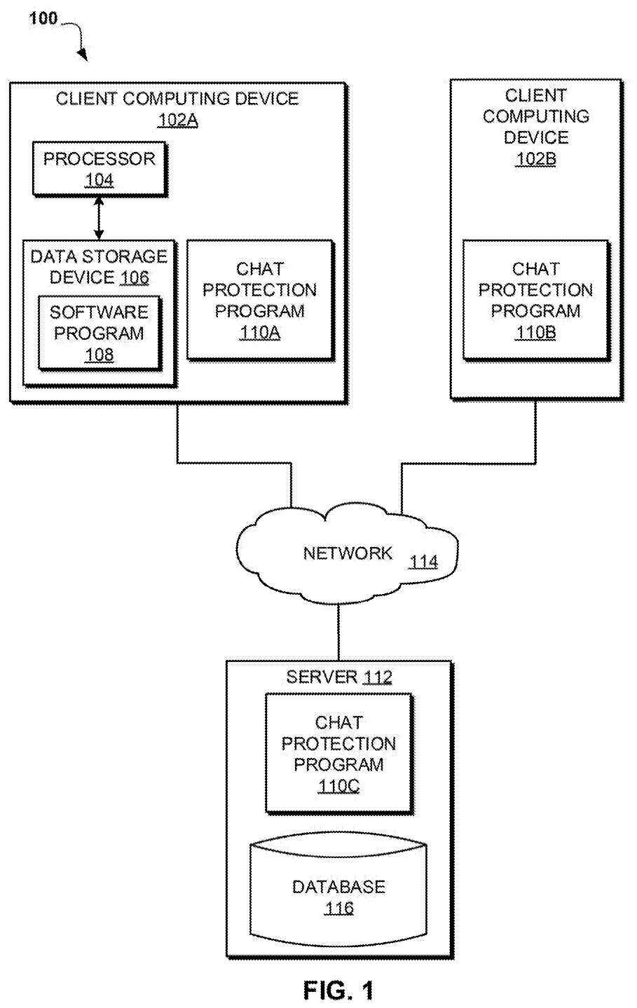

Referring to FIG. 1, an exemplary networked computer environment 100 is depicted, according to at least one embodiment. The networked computer environment 100 may include a client computing device 102A, 102B and a server 112 interconnected via a communication network 114. According to at least one implementation, the networked computer environment 100 may include a plurality of client computing devices 102A, 102B of which only two are shown for illustrative brevity. According to at least one implementation, the networked computer environment 100 may include a plurality of servers 112 of which only one is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

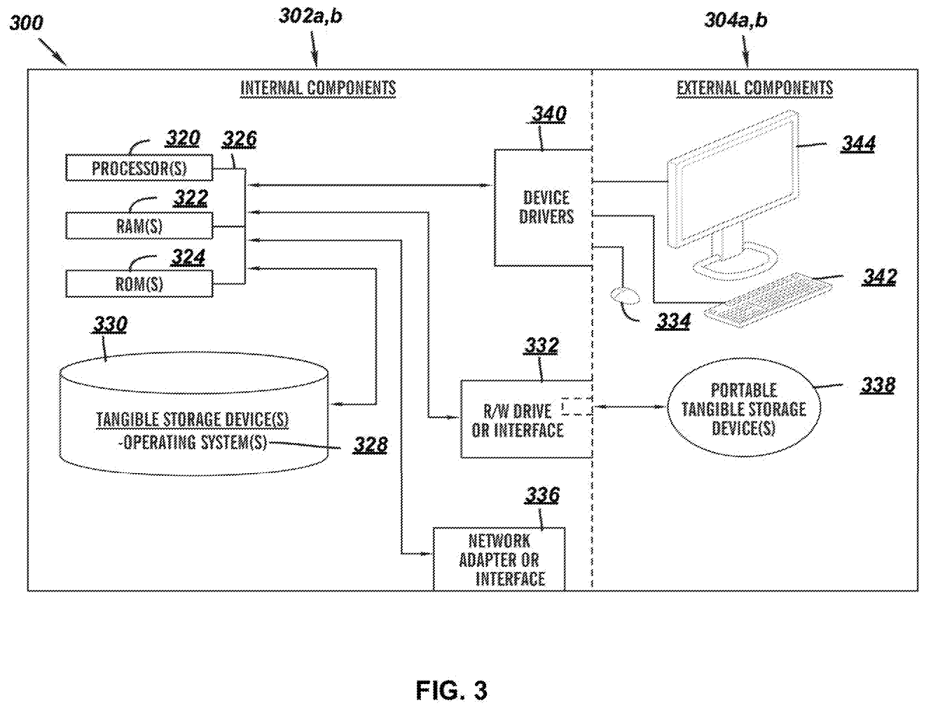

Client computing device 102A may include a processor 104 and a data storage device 106 that is enabled to host and run a software program 108 and a chat protection program 110A and communicate with the server 112 via the communication network 114, in accordance with one embodiment of the invention. For illustrative brevity, the components of client computing device 102B are omitted from the illustration in FIG. 1. However, client computing device 102B may be the same or substantially similar to client computing device 102A. Client computing devices 102A, 102B may individually be, for example, a video gaming console, a mobile device, a telephone, a personal digital assistant, a netbook, a laptop computer, a tablet computer, a desktop computer, or any type of computing device capable of running a program and accessing a network. Client computing devices 102A, 102B may also be capable of receiving user-spoken voice data through a communicatively coupled microphone, or other speech capture device, through either an internal or external connection. As will be discussed with reference to FIG. 3, the client computing devices 102A, 102B may include internal components 302 and external components 304, respectively.

The server computer 112 may be a laptop computer, netbook computer, personal computer (PC), a desktop computer, or any programmable electronic device or any network of programmable electronic devices capable of hosting and running a chat protection program 110B and a database 116 and communicating with the client computing device 102 via the communication network 114, in accordance with embodiments of the invention. As will be discussed with reference to FIG. 3, the server computer 112 may include internal components 302 and external components 304, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

In at least one embodiment, the software program 108 may be a video game program playable by a user or a group of users in a multiplayer environment with voice chat functionality. The multiplayer environment may allow for multiplayer functionality through two or more players individually playing through the communication network 114 on two or more individual client computing devices 102A, 102B. In at least one other embodiment, two or more users may interact with the software program 108 locally on a single client computing device, such as client computing device 102A, while also interacting with one or more other users on a separate client computing device 102B via the communication network 114. In yet another embodiment, the software program 108 may be a collaboration or a cloud collaboration program that allows users to perform voice chat functions. Although the examples provided herein describe voice chat scenarios, software implementing video chat functionality may also be used and remediated by the chat protection program 110A, 110B, 110C.

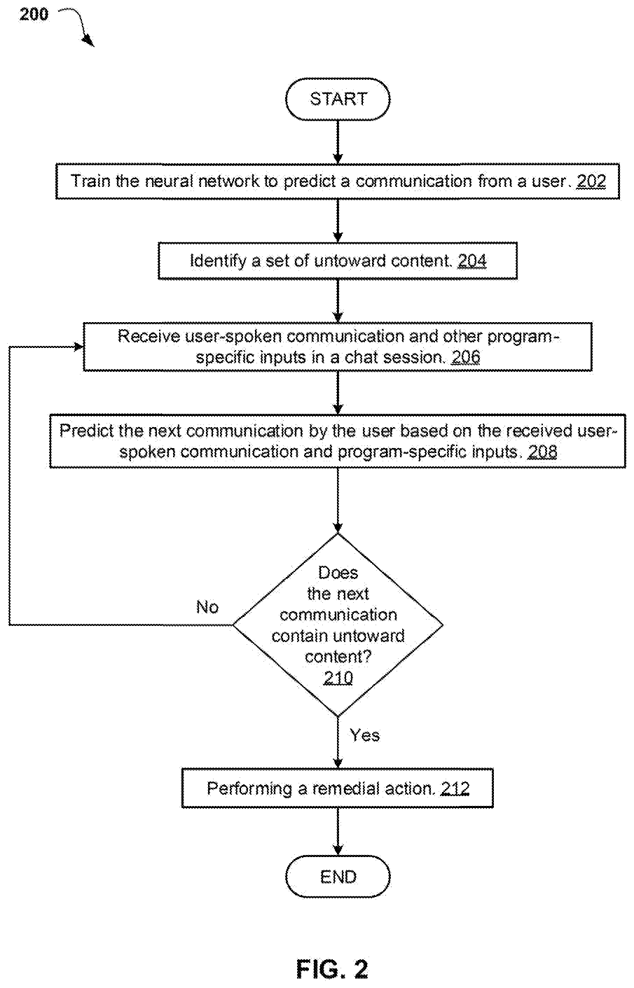

According to the present embodiment, the chat protection program 110A, 110B, 110C may be a program capable of capturing spoken voice data in a chat environment from a sensor, such a microphone communicatively couple with a user device, such as client computing devices 102A, 102B. The spoken voice data may be analyzed along with state data from the software program 108 by a neural network to predict subsequent words or phrases that may be spoken by a user in the chat environment. The predicted subsequent words or phrases may be compared with a dictionary of untoward content to determine a match exists, which may indicate that untoward content is present in the predicted words or phrases. Upon determining untoward content is present, the chat protection program 110A, 110B, 110C may perform a remedial action against the sender and/or the recipient. The chat protection method is explained in further detail below with respect to FIG. 2.

FIG. 2 is an operational flowchart illustrating a chat protection process 200 according to at least one embodiment. At 202, the chat protection program 110A, 110B, 110C trains the neural network to predict a communication from a user. In at least one embodiment, the chat protection program 110A, 110B, 110C may include a recurring neural network or long short-term memory (LSTM) network in order to perform prediction functions. Using the neural network, the prediction function may predict and present words or phrases to a user composing speech based on words or phrases commonly utilized by other users, possibly even including the current user's own previously used words or phrases, stored in a repository, such as database 112.

The chat protection program 110A, 110B, 110C may train an ensemble deep neural network model to predict the next word or phrase given a series of words or phrases immediately preceding user-spoken speech. Several input and output features during the training phase may be utilized by the chat protection program 110A, 110B, 110C based on the type of program utilizing the voice chat functionality. Inputs utilized may include audio transcription from a preconfigured amount of time across a series of users, recent events occurring during operation of the software program 108, and user profile information associated with the software program 108. In a video game context, the recent events may include points gained, points lost, enemy appearing, player avatar status (e.g., health status and current status effects), user or other player speech volume, user or other player speech inflection, and user or other player speech tone. In the context of user collaboration software, the recent events may include other participant speech, other participant tone, other participant inflection, other participant voice volume, images displayed to the collaboration participants, duration of the collaborative session, and a determined mood of other collaboration participants. The user profile information may include user age, user location, user avatar image, amount of time of current user session, total amount of time the user has used the software program 108. The output the chat protection program 110A, 110B, 110C may display is the next word or phrase likely to be spoken by a user.

In at least one embodiment, the chat protection program 110A, 110B, 110C may incorporate user biometrics, such as heartbeat, perspiration rate, eye movement, and respiration rate, as an additional input during the prediction process. For example, if a user playing a horror video game has an elevated heartbeat and an enemy suddenly surprises the user, the chat protection program 110A, 110B, 110C may determine the user's next spoken words are likely to contain untoward content.

Next, at 204, the chat protection program 110A, 110B, 110C identifies a set of untoward content. During the training process, the chat protection program 110A, 110B, 110C may require a dictionary of untoward content be established in order to determine whether predicted speech should have a remedial action performed. The untoward content may include swear words, words of a sexual nature, words with an associated innuendo, words or phrases associated with bullying, words or phrases with a negative connotation. The dictionary of untoward content may be stored in a repository, such as database 112. In at least one embodiment, the dictionary may include gestures that represent untoward content for a situation where the chat protection program 110A, 110B, 110C may be utilized to perform remedial actions on a video conference.

Then, at 206, the chat protection program 110A, 110B, 110C receives a user-spoken communication and other program-specific inputs in a chat session. As previously described, in order for the chat protection program 110A, 110B, 110C to predict a subsequent communication from a user to one or more other chat participants, the chat protection program 110A, 110B, 110C may receive various inputs. One such input is the immediately preceding user-spoken communication. The received communication may be in the form of a transcription of the user-spoken voice data where the transcription is performed in real-time.

Additionally, the chat protection program 110A, 110B, 110C may also receive recent events occurring during operation of the software program 108 and user profile information associated with the software program 108. As previously described, the recent events and user profile information may be specific to the type of software program 108 being utilized. For example, in a video game, the recent events may include points gained, points lost, enemy appearing, player avatar status (e.g., health status and current status effects), user or other player speech volume, user or other player speech inflection, and user or other player speech tone. However, for user collaboration software, the recent events may include other participant speech, other participant tone, other participant inflection, other participant voice volume, images displayed to the collaboration participants, duration of the collaborative session, and a determined mood of other collaboration participants.

Furthermore, in an embodiment where video chat is implemented, a received input may also include images or video for a preconfigured period that may coincide with the received user-spoken communication.

Next, at 208, the chat protection program 110A, 110B, 110C predicts the next communication by the user based on the received user-spoken communication and the program-specific inputs. Using the received inputs, the chat protection program 110A, 110B, 110C may calculate the next likely communication to be presented in the chat. In at least one embodiment, the chat protection program 110A, 110B, 110C may calculate a probability score for each of a plurality of likely next communications based on the inputs. For example, in the instance where the chat protection program 110A, 110B, 110C determines that phrases A, B, and C are the three most likely phrases to be the next communication by a user in a voice chat session. The chat protection program 110A, 110B, 110C may identify the next communication as the word or phrase that receives the highest probability score based on the received inputs. For example, in the previous scenario, if the probability scores of phrases A, B, and C are 75%, 71%, and 73%, the chat protection program 110A, 110B, 110C may identify phrase A as the next communication.

Then, at 210, the chat protection program 110A, 110B, 110C determines whether the next communication contains untoward content. According to one implementation, the chat protection process 200 may continue if the next communication contains untoward content. The chat protection program 110A, 110B, 110C may determine the next communication contains untoward content by comparing the predicted next communication with each word and phrase within the set of untoward content. If the predicted next communication contains a word or phrase included within the set of untoward content, the chat protection program 110A, 110B, 110C may determine that the next communication contains untoward content. If the chat protection program 110A, 110B, 110C determines the next communication contains untoward content (step 210, “Yes” branch), the chat protection process 200 may continue to step 212 to perform a remedial action. If the chat protection program 110A, 110B, 110C determines the next communication does not contain untoward (step 210, “No” branch), the chat protection process 200 may return to step 206 to receive additional user-spoken communications and other program-specific inputs in the chat session.

In at least one embodiment, the chat protection program 110A, 110B, 110C may determine a video chat session contains untoward content by comparing captured user movements with stored untoward content movements in the set of untoward content. The comparison may be made using known image recognition technology.

Then, at 212, if the calculated probability does exceed the preconfigured threshold, the chat protection program 110A, 110B, 110C performs a remedial action. The chat protection program 110A, 110B, 110C may perform one or more remedial actions if a predicted word or phrase is determined to contain untoward content. The remedial action may be taken toward the sender, the recipient, or both. With respect to the recipient, the remedial action may include muting or bypassing transmission of the received audio for the only the recipient based on characteristics within a user profile. For example, if one recipient within a group of recipients is a minor, the untoward content may be muted for or not transmitted to the minor recipient but may not be muted for and transmitted to the other users in the group that are not minors. In another embodiment, the untoward content may be muted or not transmitted to all of the chat participants. In yet another embodiment, the untoward content may have an audio tone played in place of or over the untoward word or phrase, such as seen in a “bleep” used in television broadcasts.

With respect to remedial actions focused on the sender, the chat protection program 110A, 110B, 110C may disable a microphone for the sender of untoward content. In at least one embodiment where the a video chat captures untoward video content, the chat protection program 110A, 110B, 110C may disable the sender image capture device either while untoward content is predicted or for a preconfigured period of time.

Additionally, the chat protection program 110A, 110B, 110C may transmit a notification to the sender about untoward content in an attempt to move the sender of the untoward content toward calmer behavior. The notification may be presented in the form of an environment change or a notification. For example, an environment change may include altering a background color. The notification may involve either a text popup or an audio voiceover warning the user of the untoward content.

Furthermore, the chat protection program 110A, 110B, 110C may replace the untoward content with an audience-appropriate synonym. For example, if the chat protection program 110A, 110B, 110C determines a minor is present in a chat group and detects an untoward word or phrase has been spoken by a user in the group, the chat protection program 110A, 110B, 110C may identify a synonym for the untoward word or phrase to with which to replace the untoward word or phrase using known sound editing techniques.

It may be appreciated that FIG. 2 provides only an illustration of one implementation and does not imply any limitations with regard to how different embodiments may be implemented. Many modifications to the depicted environments may be made based on design and implementation requirements. For example, the chat protection program 110A, 110B, 110C may be utilized with various live streaming software, such as television streaming services, radio streaming services, and podcasts, as a replacement for multi-second delay techniques to detect untoward content and apply appropriate remedial actions.

In another embodiment, the chat protection program 110A, 110B, 110C may allow users to provide performance feedback where audio should have or should have been remediated. For example, if untoward content was allowed to be presented, a user may be provided with an option on a graphical user interface to notify the chat protection program 110A, 110B, 110C that a remediation action should have been performed on the allowed untoward content. Similarly, if content was mistakenly remediated when it should not have been, a user may interact with a graphical user interface, either directly through a touchscreen or a communicatively-coupled peripheral device, to aide the chat protection program 110A, 110B, 110C in machine learning to improve accuracy.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing devices 102A, 102B and the server 112 may include respective sets of internal components 302 and external components 304 illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the chat protection program 110A, 110B in the client computing devices 102A, 102B and the chat protection program 110C in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the chat protection program 110A, 110B, 110C, can be stored on one or more of the respective portable computer-readable tangible storage devices 338, read via the respective R/W drive or interface 332, and loaded into the respective hard drive 330.

Each set of internal components 302 also includes network adapters or interfaces 336 such as a TCP/IP adapter cards, wireless Wi-Fi interface cards, or 3G or 4G wireless interface cards or other wired or wireless communication links. The software program 108 and the chat protection program 110A, 110B in the client computing devices 102A, 102B and the chat protection program 110C in the server 112 can be downloaded to the client computing devices 102A, 102B and the server 112 from an external computer via a network (for example, the Internet, a local area network or other, wide area network) and respective network adapters or interfaces 336. From the network adapters or interfaces 336, the software program 108 and the chat protection program 110A, 110B in the client computing devices 102A, 102B and the chat protection program 110C in the server 112 are loaded into the respective hard drive 330. The network may comprise copper wires, optical fibers, wireless transmission, routers, firewalls, switches, gateway computers and/or edge servers.

Each of the sets of external components 304 can include a computer display monitor 344, a keyboard 342, and a computer mouse 334. External components 304 can also include touch screens, virtual keyboards, touch pads, pointing devices, and other human interface devices. Each of the sets of internal components 302 also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

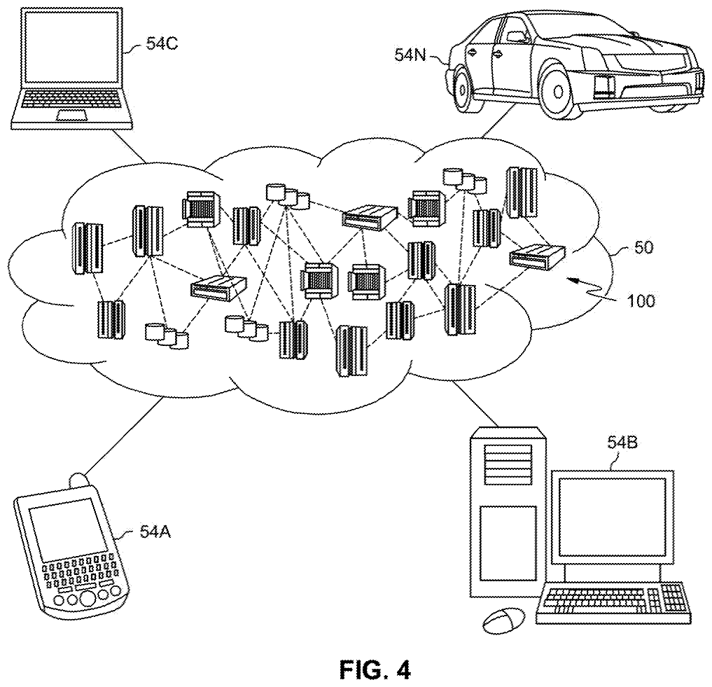

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

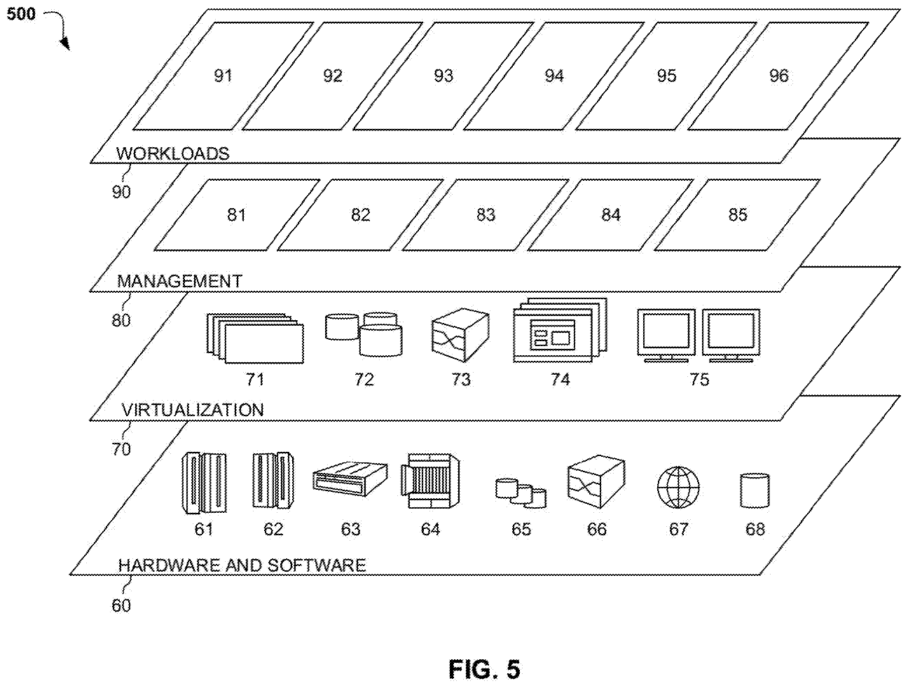

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and chat protection 96. Chat protection 96 may relate identifying untoward content spoken during a chat session and performing remedial action in order to prevent the untoward content from being transmitted or presented to one or more recipient users in the chat session.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for chat protection, the method comprising:
receiving, in a chat session, a user-spoken communication and one or more inputs specific to a software program;
predicting a next communication by the user based on the received user spoken communication and the one or more inputs; and
in response to the predicted next communication containing untoward content, performing a remedial action.

2. The method of claim 1, wherein the remedial action is selected from a group consisting of muting a recipient speaker, disabling a sender microphone, bypassing transmission of audio to a recipient, playing an audio tone in place of the untoward content, transmitting a notification to a sender of the untoward content.

3. The method of claim 1, further comprising:
generating a database containing one or more words or phrases that qualify as untoward content based on user preconfiguration; and
determining whether the predicted next communication contains untoward content based on a comparison of the predicted next communication and the database.

4. The method of claim 3, wherein the untoward content is selected from a group consisting of explicit words, innuendos, and words or phrases associated with bullying.

5. The method of claim 1, further comprising:
training a neural network to predict a communication from a user.

6. The method of claim 1, wherein the one or more inputs are selected from a group consisting of audio transcription for a preconfigured amount of time in the chat software across a series of users, recent events occurring during operation of the software program, and user profile information associated with the software program.

7. The method of claim 6, wherein the software program is a video game with multiplayer, chat functionality.
